(19) United States
(12) Patent Application Publication
(10) Pub. No.: US 2026/0036203 A1
(43) Pub. Date: Feb. 5, 2026

(54) SEAL SYSTEM

(71) Applicant: JOHN CRANE UK LIMITED, Slough (GB)

(72) Inventors: Carlo Del Vescovo, Andria (IT); Chandran Sreejith, Dubai (AE); Oryeshkin Yuriy, Dubai (AE); Jonathan Amos, Broken Arrow, OK (US)

(73) Assignee: JOHN CRANE UK LIMITED, Slough (GB)

(21) Appl. No.: 19/274,847

(22) Filed: Jul. 21, 2025

Related U.S. Application Data
(60) Provisional application No. 63/677,533, filed on Jul. 31, 2024.

(51) Int. Cl. F16J 15/14

(52) U.S. Cl. CPC F16J 15/14

(57) ABSTRACT

A seal system for rotating equipment operating on a process fluid includes: a seal configured for use with a seal gas for sealing rotating equipment; a liquid ejector subsystem; and means for conveying the seal gas stream from the liquid-gas separator of the liquid ejector subsystem to the seal. The liquid ejector subsystem includes: a liquid ejector comprising an inlet for fluidic communication with a source of liquid, an inlet for fluidic communication with a source of seal gas, and an outlet for a liquid-gas composition; a liquid-gas separator, which is in fluidic communication with the outlet of the liquid ejector, for forming a separate seal gas stream and a separate liquid stream from the liquid-gas composition; and a pump for increasing the pressure of the liquid source for the liquid ejector.

### CROSS-REFERENCE TO RELATED APPLICATION

This application claims the benefit of priority under 35 U.S.C. § 119(e) to U.S. Provisional Patent Application Ser. No. 63/677,533, filed Jul. 31, 2024. The entire content of this application is hereby incorporated by reference herein.

### TECHNICAL FIELD

The present invention relates to a seal system for rotating equipment operating on a process fluid, said seal system comprising a seal configured for use with a seal gas, and a liquid ejector subsystem configured to increase the pressure of a supply of seal gas to the seal. The present invention also relates to a process for providing a seal gas for a seal configured for use with a seal gas and used for sealing rotating equipment operating on a process fluid, said process comprising the use of a liquid ejector.

### BACKGROUND

Rotating equipment intended for operation on a process fluid typically include axial, centrifugal, and rotary screw compressors and expanders for use in oil refineries, as well as petrochemical facilities, gas plants, liquefied natural gas (LNG) facilities and oil and gas production facilities. A common application for seal systems is in connection with centrifugal compressors which are typically used at intervals along a natural gas pipeline to boost the gas pressure for processing, to counter the effect of flow losses along the transmission pipelines and to facilitate movement of the gas towards its destination. These compressors can be used upstream (during exploration and production), midstream (during processing, storage and transportation), or downstream (during natural gas/and petrochemical refining, transmission and distribution) in a petrochemical process.

To move natural gas or other fluids, centrifugal compressors use a rotating disk or impeller contained in a housing to increase the pressure of a process gas. The rotation of the disk/impeller is provided by a rotating shaft that is driven by an external motor or turbine. The shaft can be mated to the rotor of the compressor that carries the disk/impeller. Non-contacting seals which rely on a gas lubrication may be used in connection with rotating equipment, a common example of which being the dry gas seal. Dry gas seals surround the rotor at or near where the rotor enters housing to form a seal that prevents the process gas from escaping at that location.

In general, dry gas seals operate by providing a seal between a rotating ring and a stationary ring. The rotating ring is sometimes referred to as a “mating ring” as it is mated to the rotating shaft/rotor. The rotating ring can be mated to the rotor via a shaft sleeve. The stationary ring, also known as the “primary ring”, does not rotate during operation.

In operation, a layer of gas is developed between the two rings that forms a seal while allowing the rings to move relative to one another without contacting each other. The gas layer may be formed from seal gas injected into the dry gas seal. Grooves in the rotating (mating) ring draw the process gas from an outer radial edge of the mating ring to a location in between the two rings. The gas that is drawn into the grooves is compressed as it moves toward the radially inward ends (or tips) of the grooves. The compressed gas creates a pressure dam that causes the primary ring to “lift off” from the mating ring to form a running gap that is in the range of few microns (e.g., 3-10 μm). To allow for relative axial movement between the rings, the primary ring is typically mounted to a stationary portion of the dry gas seal by a compressible member such as a spring or other implement. After liftoff, a very small amount of gas flows over the dam area to the low pressure side of the seal (e.g., outside of the compressor), creating a controlled seal leakage, and the rings operate on the thin film of gas as a non-contacting seal.

Non-contacting seals such as dry gas seals or floating ring seals may be used to reduce frictional wear on the rotating components while preventing leakage of the centrifuged or processed gas. To further inhibit leakage of processed gas into the atmosphere, some centrifugal compressors can include a pair of dry gas seals working in tandem. One example of such a mechanical seal system is described in U.S. Pat. No. 8,651,801, and another example is described in U.S. Pat. No. 10,871,167, the contents of which are incorporated by reference herein.

The performance of non-contacting, gas lubricated seals relies on a flow of seal gas (also known as “barrier gas”) to the seal chamber of the seal, which is pressurized to a higher pressure than the process fluid on which the rotating equipment is operating to prevent leakage of process fluid into the seal cavity. Seal gas supplied to the seal chamber typically defines a fluidic path between the rotating members and the stationary members, so as to provide gas lubrication, and serves to regulate and control the environment, including temperature, within the seal chamber. The flow of seal gas within the seal chamber is ultimately defined by the configuration of the seal (e.g. double seal or tandem seal arrangement) and the arrangement of inputs/vents to and from the seal chamber.

Pressurised seal gas is often supplied in conventional systems by means of reciprocating compressors which have a high energy footprint, a substantial maintenance burden, and low reliability. When used in continuous process fluid compression or expansion processes, reciprocating compressors can limit the lifetime of the process before repairs and maintenance are required and extend the periods over which production/output is halted. There remains a need for alternative means for providing pressurized seal gas for gas lubricated, non-contacting seals which can offer different capital expenditure (CapEx) and operational expenditure (OpEx) solutions for operating process fluid compression or expansion processes.

### SUMMARY OF INVENTION

In one aspect, there is provided a seal system for rotating equipment operating on a process fluid, wherein the system comprises:
i) a seal configured for use with a seal gas for sealing rotating equipment;
ii) a liquid ejector subsystem comprising:
   a) a liquid ejector comprising an inlet for fluidic communication with a source of liquid, an inlet for fluidic communication with a source of seal gas, and an outlet for a liquid-gas composition;
   b) a liquid-gas separator, which is in fluidic communication with the outlet of the liquid ejector, for forming a separate seal gas stream and a separate liquid stream from the liquid-gas composition;
   c) a pump for increasing the pressure of the liquid source for the liquid ejector; and
iii) means for conveying the seal gas stream from the liquid-gas separator of the liquid ejector subsystem to the seal;
   wherein the liquid ejector subsystem is configured to increase the pressure of a supply of seal gas to the seal and arranged so that the pump is at least partly supplied by the liquid stream formed by the liquid-gas separator during operation.

In another aspect, the present invention provides a process for providing a seal gas for a seal configured for use with a seal gas for sealing rotating equipment operating on a process fluid; said process comprising the following steps:
i) providing a liquid ejector comprising an inlet for fluidic communication with a source of liquid, an inlet for fluidic communication with a source of seal gas, and an outlet for a liquid-gas composition;
ii) providing a source of liquid and a source of seal gas to the liquid ejector, wherein the pressure of the source of liquid is higher than that of the source of seal gas, and forming a liquid-gas composition;
iii) separating a seal gas stream and a liquid stream from the liquid-gas composition, said seal gas stream having a higher pressure than the source of seal gas provided to the liquid ejector; and
iv) conveying the seal gas stream obtained from the liquid-gas separator to the seal.

### BRIEF DESCRIPTION OF THE DRAWINGS

The disclosure can be more completely understood in consideration of the following detailed description by reference to the accompanying drawing, in which:

FIG. 1 is a schematic drawing of a liquid ejector subsystem and a seal gas supply loop for a gas lubricated, non-contacting seal; and

FIG. 2 is a cross-sectional representation of a double seal arrangement with inlet and outlet ports shown.

### DETAILED DESCRIPTION

A particular advantage of the provision of high pressure seal gas is that it is compatible for use with double-type dry gas seals, where higher pressure seal gas is desirable to ensure sealing performance and where seal gas loss to the process is acceptable. Additionally, high pressure seal gas can be desirable for use with other non-contacting, gas lubrication seal types, for instance, those intended to seal higher pressure process fluids, since the pressure of the seal gas must typically be at least 3.4 bar (50 psig) higher than the process fluid in order to prevent ingress into the seal cavity.

The seal gas pressure may nevertheless be controlled and regulated using differential pressure control or flow control systems, depending on the particular requirements of the seal in question. Differential control systems control the supply of seal gas to the seal by regulating the seal gas pressure to a pre-determined value above the sealing pressure (i.e. the pressure of the process fluid) using a differential pressure control valve. Flow control systems control the supply of seal gas to the seal by regulating the seal gas flow through an orifice upstream of the seal using a differential pressure control valve to monitor pressures on either side of the orifice.

The present disclosure utilises a liquid ejector loop as a reliable means for providing a high pressure flow of seal gas with comparatively little maintenance requirements, in contrast to the use of reciprocating compressors. When maintenance downtime is factored in for systems and operations utilising reciprocating compressors to generate seal gas, and particularly for systems generating high pressure seal gas, then the economics of the process and system of the present disclosure can be particularly advantageous.

Thus, in one aspect, there is provided a seal system for rotating equipment operating on a process fluid, wherein the system comprises:
i) a seal configured for use with a seal gas for sealing rotating equipment;
ii) a liquid ejector subsystem comprising:
   a) a liquid ejector comprising an inlet for fluidic communication with a source of liquid, an inlet for fluidic communication with a source of seal gas, and an outlet for a liquid-gas composition;
   b) a liquid-gas separator, which is in fluidic communication with the outlet of the liquid ejector, for forming a separate seal gas stream and a separate liquid stream from the liquid-gas composition;
   c) a pump for increasing the pressure of the liquid source for the liquid ejector; and
iii) means for conveying the seal gas stream from the liquid-gas separator of the liquid ejector subsystem to the seal;
   wherein the liquid ejector subsystem is configured to increase the pressure of a supply of seal gas to the seal and arranged so that the pump is at least partly supplied by the liquid stream formed by the liquid-gas separator.

Rotating equipment typically includes a motor-driven shaft that drives a rotatable component, such as an impeller for compression/pumping of a gas/liquid. The rotating equipment to which the seal system of the present disclosure may be applied is not particularly limited and includes all axial, centrifugal and rotary screw compressors and expanders, as well as centrifugal pumps for operation on certain process liquids, including in supercritical applications. Particularly preferred rotating equipment for use with the present seal system are centrifugal compressors and expanders, most preferably centrifugal compressors. The process fluid on which the rotating equipment operates is not particularly limited and includes all industrial gases, liquids or supercritical fluids that may require pumping, compression or expansion. Examples include hydrocarbon-based gases, such as natural gas, as well as hydrocarbon liquids, including liquid natural gas (LNG).

Seals which are for use with a seal gas are non-contacting, gas lubricated seals which include, without limitation, dry gas seals and floating ring type seals. Preferred examples of dry gas seals for use in the seal system of the disclosure include double seals (e.g. in back-to-back arrangement), and tandem-type dry gas seals with an intermediate labyrinth. For instance, in the case of tandem type dry gas seals, seal gas flows across the primary seal (inboard stage) of the dry gas seal out towards the primary vent, and across the inboard process labyrinth, back into the process. The seal gas can be differential-pressure controlled to ensure the seal gas is at higher pressure than the primary seal vent. In a double-type dry gas seal, seal gas is injected between the primary and secondary seals at a higher pressure than the product pressure. One part of the seal gas leakage escapes to the atmosphere side and the other part to the product side. Double seals may also be readily configured for recycle of the seal gas from and to the seal chamber, as illustrated in FIG. 2.

Seals that are suitable for use as non-contacting, gas lubricated seals are well known to the skilled person and include those of conventional construction and composition. A mating ring suitable for use in such seals may, for instance, be formed from cast iron, stainless steel, Ni-resist, titanium alloys, ceramic (Al₂O₃), silicon nitride, silicon carbide, tungsten carbide, and graphite composites. The primary ring for use in such seals may, for instance, be formed of carbon graphite, and ceramic (Al₂O₃), stainless steel, tungsten carbide and silicon carbide.

In some embodiments, the seal system employed is a dry gas seal system, preferably a dry gas seal system which conforms to American Petroleum Institute (API) 692 or API 614.

The liquid ejector that forms a part of the liquid-ejector subsystem has been found to provide a simple, robust and reliable method for pressurizing seal gas. The operation is based on Bernoulli's principle, in which increasing the velocity of a high pressure liquid as a result of passing through a nozzle creates a low pressure region within the ejector. This low pressure region entrains and compresses the low pressure seal gas stream (also known as the “suction fluid” in the context of liquid ejectors). In practice, a rotating distributor within the liquid ejector takes the pumped, high pressure liquid stream and orientates and stabilises its flow before it is passed through a nozzle that provides a high velocity jet of fluid to create suction in the gas chamber and entrain gas into the ejector. As the combined stream passes through the ejector's diffuser section, there is a rapid dissipation of kinetic energy which creates an intensive mixing zone where the velocity decreases and the pressure is regained. This forms a liquid-gas composition, typically where the gas forms a fine dispersion within the liquid, having an intermediate pressure, which lies between that of the high pressure liquid stream and the low pressure seal gas stream fed to the ejector.

Any conventional liquid ejector which is compatible with a liquid stream of water, oil, or combination thereof, and an inert seal gas stream may be used in connection with the present disclosure. Suitable liquid ejectors are for instance available from Transvac, Croll Reynolds Inc., and others. Known liquid ejectors are capable of compressing gas from atmospheric pressure to over 150 bar·g, due to their very high energy dissipation rates and high mass-transfer coefficient. Liquid ejectors offer more efficient gas compression when compared with gas ejectors. However, liquid-gas separation is required downstream. As a consequence, the liquid-ejector subsystem of the present disclosure also includes a liquid-gas separator.

The liquid ejector may be operated in a single stage or multi-stage configuration. Thus, the system and methods of the present disclosure may be operated with multiple liquid ejectors each with its own corresponding liquid-gas separator. Thus, for example, a high pressure liquid stream may be split into separate feed streams for two liquid ejectors, and seal gas separated from a liquid-gas composition from one of the two ejectors may be subsequently fed as the source of seal gas to the second ejector from which the high pressure seal gas for providing to the seal is ultimately derived. Such an arrangement may be less advantageous from a CAPEX perspective but it can offer OPEX savings in some arrangements.

The liquid-gas separator separates liquid and gas streams from the liquid-gas composition discharged from the liquid ejector, preferably with as little pressure drop in the gas stream which is obtained from the liquid-gas composition as possible. Liquid-gas separators are operable under high pressure environments, whilst maintaining separation efficiency, and can be configured based on the pressures of the system to which they are integrated. Liquid-gas separators are also robust and reliable devices with very low maintenance requirements that makes them particularly suitable for use in combination with the liquid ejector, which similarly benefits from high reliability and low maintenance requirements. Suitable separators may be vertical or horizontal vessel, acting as 2-phase (e.g. water or oil/gas mixtures) or 3-phase separators (e.g. water/oil/gas mixtures), for instance operating by gravity separation or centrifugal separation.

Depending on the configuration, separation efficiency in the liquid-gas separator is typically suitable for removing water/oil droplets larger than approximately 300 microns from the seal gas, although separation efficiency can be optimised for improved performance. Nevertheless, the seal gas system may include gas conditioning units (GCU) which are common in seal gas systems to ensure the seal gas is sufficiently clean and dry for use as a seal gas to avoid contamination of the seal cavity which can lead to failures. Thus, in some embodiments, the seal system of the present disclosure further comprises a gas conditioning unit for filtering and/or drying the seal gas stream formed in the liquid-gas separator to remove any residual vapour and liquid particles before being conveyed to the seal.

GCUs typically include filters (coalescing and separators), heaters, boosters, and coolers, all of which may be required in order, for instance, to satisfy the requirements of API 692. Filtration of seal gas is usually to an extent which removes particulate of diameters above 3 microns, whilst heaters and coolers are used for dew point control. Flowmeters may be included in the supply lines of the seal system to the seal chamber in order to monitor the gas stream to the seal. Flow meters may also be positioned in vent(s). Flow monitoring vastly improves the fidelity of the system and helps with diagnostics of seal performance anomalies in the field.

Additionally, a monitoring and control system may also be integrated with the seal gas system that is responsive to liquid, vapor or condensate, utilising for instance, an evanescent wave sensor, as well as temperature and pressure sensors disposed along the conduit at the outlet of the GCUs. A leading cause of seal failure is liquid condensate in the seal environment, and such a monitoring and control system may therefore be used to provide a warning or correction to ensure that liquid fluid does not reach the seal chambers.

The liquid-ejector is supplied with a high pressure liquid which may be water, oil or a combination thereof. Preferably, the high pressure liquid supplied to the liquid ejector comprises, or consists essentially of, water. The high pressure liquid is produced by a pump which is included in the liquid-ejector subsystem. Any suitable pump may be used which is capable of converting a liquid stream having a pressure of approximately 1 to 4 bar·a, to a pumped liquid stream having a pressure up to 400 bar·a. Examples of suitable pumps for use in the liquid ejector subsystem include centrifugal, reciprocating, or rotary pumps. Suitable pumps include semi-hermetic or preferably hermetic pumps. Well known suppliers of suitable pumps include, for instance, Rurhpumpen, Hughes Pumps Ltd., and others.

The liquid ejector subsystem may additionally include a cooling means for cooling the liquid stream formed by the liquid-gas separator before recycle to the pump. The cooling may be necessary in order to counteract heat generated by the losses mainly occurred in the liquid ejector. Therefore, in order to manage the heating effects of the liquid ejector, a cooling means may be present to control the temperature of the liquid recycle stream to the pump.

The liquid ejector is supplied with a low pressure seal gas which is converted to a high pressure seal gas stream following interaction with the liquid ejector and subsequent separation of a pressurised seal gas stream from the liquid-gas composition discharged from the liquid ejector. The seal gas which is supplied to the liquid ejector is inert and typically selected from nitrogen, carbon dioxide, air, and combinations thereof. Preferably, the seal gas comprises, or consists essentially of, nitrogen.

In some embodiments, the pressure of the seal gas supply to the liquid ejector which is to be pressurized is less than 10 bar·a, preferably from 1 to 6 bar·a, more preferably from 1 to 4 bar·a.

In some embodiments, the liquid ejector subsystem is configured to provide pressurized seal gas streams for a plurality of seals. In this way, the benefits afforded by the liquid ejector subsystem can be extended across more complex integrated systems.

The high pressure seal gas obtained from the liquid-gas separator may be used to supply a non-contacting, gas lubricated seal to provide lubrication and avoid leakages from the process, but also to help control the seal chamber environment (e.g. temperature). Depending on the particular configuration of the seal, the high pressure seal gas is introduced by means of one or more inlets to the seal chamber and discharged via one or more outlets or vents. Since the seal gas is inert, venting to the atmosphere (as opposed to a flare stream) is possible, depending on the set up.

Typically, in the case of tandem type dry gas seals, seal gas flows across the primary seal (inboard stage) of the dry gas seal out towards the primary vent, and across the inboard process labyrinth, back into the process. The seal gas can be differential-pressure controlled to ensure the seal gas is at higher pressure than the primary seal vent. In a double-type dry gas seal, seal gas is injected between the primary and secondary seals at a higher pressure than the product pressure. One part of the seal gas leakage escapes to the atmosphere side and the other part to the product side.

Dry gas seals, particularly double seals may, however, be configured for recycle of the seal gas from and to the seal chamber. This may be achieved by the integration of an outlet port in between the inboard (primary) and outboard (secondary) seal so that seal gas that has been injected into the chamber between the inboard and outboard seal may be diverted from normal vent/leakage pathways. In this case, the additional seal gas output allows a flow of seal gas to exit the seal chamber for subsequent cooling and recycle (e.g. in the form of a closed cooling loop). FIG. 2, described in more detail below, illustrates an example of a suitable double seal arrangement in which the seal gas inlet and outlet ports have a 180° separation (i.e. occupying angular positions of 0° and 180°) around the circumference of the seal ring, but occupying the same axial position relative to the rotating shaft. This arrangement balances the flow of seal gas through the seal chamber. Alternative arrangements are also possible in which multiple inlets and outlets may be provided. For example, two inlets may be provided at −/+10° and two outlets at +170/+190°. Such an arrangement can help lower the seal gas speed, if desired.

Thus, in some embodiments, where the seal is a double seal with inboard and outboard seals in back-to-back arrangement, the seal may further comprise an outlet between the inboard and outboard seals of the double seal to allow outward flow of seal gas from the seal chamber to allow for a recycle loop. The system in this configuration may also further comprise a cooling means for cooling seal gas exiting the double seal via the outlet, in addition to means for recycling the cooled seal gas back to a seal gas inlet stream for the seal. In related embodiments, the system may further comprise a gas compressor (e.g. a seal gas booster) to optimise the flow of the cooled seal gas prior to recycle to the seal gas inlet stream for the seal. Suitable seal gas boosters include those available from John Crane.

Thus, in some embodiments, the seal system further comprises a cooling means for cooling seal gas which has been conveyed to the seal, and a means for conveying seal gas to the gas cooling means and recycling cooled seal gas to the seal. This cooling stage may, for instance, lower the temperature of the seal gas by at least 20° C., 30° C., or even 40° C. In preferred embodiments, cooling of the seal gas is sufficient to reduce the temperature to 80° C. or below, preferably 70° C. or below.

Whilst there are advantages to providing a high pressure seal gas, the greater the pressure of the seal gas the greater the heat that is generated in the seal gas as a result of its path through the seal chamber. For instance, in some systems, the temperature of the seal gas which has flowed through the seal chamber may exceed 100° C., 110° C. or even 120° C.

In some embodiments, the system further comprises a gas compressor, such as a seal gas booster, for compressing the cooled seal gas discharged from the seal prior to being recycled to the seal. Such a gas compressor may usefully generate flow on the cooling loop and thus is not relied upon to provide additional pressure to the recycled stream, and therefore does not impact OPEX significantly.

Where there is seal gas leakage escape to the atmosphere side of the seal, it is also possible to include a seal gas recovery (SGR) subsystem to recover the seal gas leakage for recycle. Such SGR subsystems are known in the art and can be retrofitted into existing set ups and can allow, for instance, recycle of seal gas back to the liquid ejector in the present process. This may be beneficial to the overall economics of the system in certain arrangements, particularly where consistent supply of seal gas may be more problematic.

In another aspect, there is provided a process for providing a seal gas for a seal configured for use with a seal gas for sealing rotating equipment operating on a process fluid; said process comprising the following steps:
i) providing a liquid ejector comprising an inlet for fluidic communication with a source of liquid, an inlet for fluidic communication with a source of seal gas, and an outlet for a liquid-gas composition;
ii) providing a source of liquid and a source of seal gas to the liquid ejector, wherein the pressure of the source of liquid is higher than that of the source of seal gas, and forming a liquid-gas composition;
iii) separating a seal gas stream and a liquid stream from the liquid-gas composition, said seal gas stream having a higher pressure than the source of seal gas provided to the liquid ejector; and
iv) conveying the seal gas stream obtained from the liquid-gas separator to the seal.

As will be appreciated, embodiments described above in connection with the system may also apply to the above recited process. For instance, the seal gas, source of liquid, liquid ejector, seal employed in the process may be as described hereinbefore.

In some embodiments, the source of liquid for the liquid ejector has a pressure of from 200 to 500 bar·a, preferably from 250 to 450 bar·a, or more preferably 275 to 325 bar·a. In some embodiments, the source of seal gas provided to the liquid ejector is at a pressure of less than 10 bar·a, preferably from 1 to 6 bar·a, more preferably from 1 to 4 bar·a.

In some embodiments, the process further comprises pumping a liquid source with a pump to provide a pressurised source of liquid for the liquid ejector. As described herein in connection with the system, suitable pumps include centrifugal, reciprocating, or rotary pumps. Suitable pumps include semi-hermetic or preferably hermetic pumps. Preferably, the supply of liquid to the pump is at least in part provided by a liquid recycle stream separated from the liquid-gas composition formed by the liquid ejector. This in effect provides a loop for liquid supplying the liquid ejector which may be closed or open depending on the configuration of the system. In some embodiments, the process further comprises cooling the liquid recycle stream separated from the liquid-gas composition using a cooling means before the stream is recycled to the pump.

The seal gas stream separated from the liquid-gas composition formed by the liquid ejector preferably has a pressure of from 50 to 120 bar·a, more preferably from 60 to 100 bar·a, even more preferably 70 to 90 bar·a. In some embodiments, the process further comprises filtering and/or drying the seal gas stream separated from the liquid-gas composition to remove any residual vapour and liquid particles before being conveyed to the seal. This may be achieved through the use of one or more gas conditioning units (GCUs) described hereinbefore.

The seal gas stream obtained from the liquid-gas separator and conveyed to the seal for providing gas lubrication and for controlling the environment of the seal chamber is preferably at least 5 bar, preferably at least 10 bar higher in pressure than the process fluid on which the rotating equipment operates. The rotating equipment is preferably a centrifugal compressor and the process fluid preferably comprises methane (e.g. a natural gas stream). In some embodiments, the rotating equipment is a centrifugal compressor for a gas pipeline and the seal gas stream provided to the seal has a pressure of from 50 to 120 bar·a, preferably from 60 to 100 bar·a, more preferably 70 to 90 bar·a.

The source of seal gas provided to the liquid ejector is preferably at least partly supplied by seal gas recovered from the process by a seal gas recovery (SGR) subsystem. SGRs may be selected based on the particular configuration of the seal. In preferred embodiments, the seal is a tandem type seal with intermediate labyrinth that is used in a process incorporating a SGR subsystem.

In some embodiments of the process, the seal is a double seal with inboard and outboard seals in back-to-back arrangement further comprising an outlet between the inboard and outboard seals of the double seal to allow outward flow of seal gas from the seal chamber. Preferably, the process further comprises cooling seal gas exiting the double seal via the outlet, for instance using a cooling means, and recycling the cooled seal gas back to a seal gas inlet stream for the seal. This reduces seal gas consumption and reduces the extent to which GCUs may be relied upon since a clean supply of seal gas may be recycled to the system. In some embodiments, the cooled seal gas may be compressed, for example with a seal gas booster, prior to recycling to the seal gas inlet stream. This may be useful for ensuring adequate flow of seal gas through the cooling loop before supply to the seal gas inlet stream.

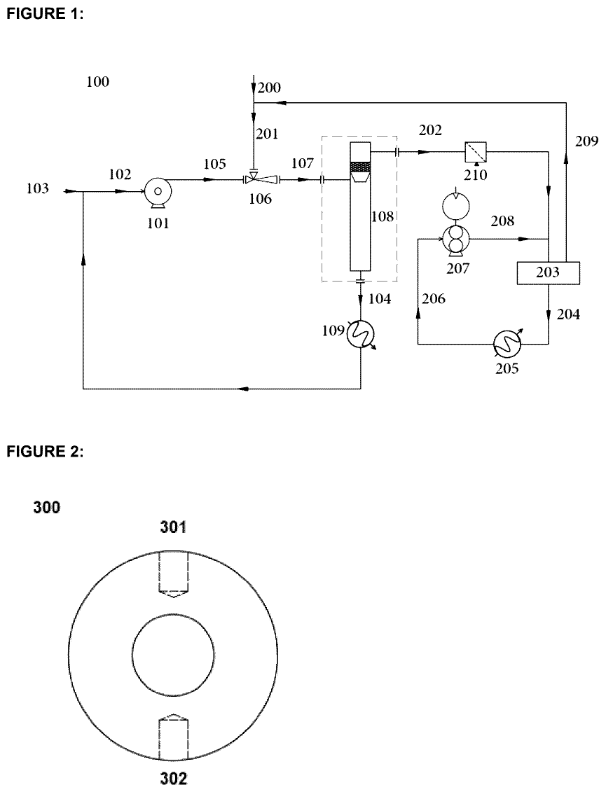

The system and process of the present disclosure will now be further described with reference to FIG. 1 which shows a schematic representation of the system 100 and process. A source of liquid 102, which may for instance be water, oil, or combinations thereof, is supplied to a preferably hermetically sealed pump 101, for example a centrifugal, reciprocating, or rotary pump. A liquid stream 102 supplying the pump 101 can be partly or fully supplied from a stream of liquid 103 from an external source or may be partly or fully supplied from a liquid recycle stream 104 from the process. For example, liquid recycle stream 104 may form a part of a closed or open liquid loop system which incorporates supply and recycle of liquid streams from the liquid ejector 106.

Pump 101 pressurizes the liquid of the liquid supply stream 102 to form a high pressure liquid stream 105, typically having a pressure of from 200 to 500 bar·a, preferably from 250 to 450 bar·a, or more preferably 275 to 325 bar·a, which supplies the liquid ejector 106. The liquid ejector 106 includes an inlet for a high pressure motive stream which is in fluidic communication with high pressure liquid stream 105 as well as a separate inlet for a low pressure “suction stream” which is in fluidic communication with a feed stream of low pressure seal gas 201, for example, at a pressure of less than 10 bar·a, preferably from 1 to 6 bar·a, more preferably from 1 to 4 bar·a, which derives from a source gas stream 200.

Operation of the liquid ejector 106 sees the high pressure liquid stream 105 enter its corresponding inlet and pass through the nozzle of the liquid ejector 106. At the same time, the low pressure seal gas stream 201 is drawn into the liquid ejector 106 through its corresponding inlet and combined with the high pressure liquid stream 105 in the diffuser of the liquid ejector 106 to produce a high pressure liquid-gas composition stream 107, which is discharged from the outlet of the liquid ejector 106. The high-pressure liquid gas composition stream 107 has a pressure which is intermediate of that of the seal gas stream 201 and the high pressure liquid stream 105 fed to the liquid ejector 106. Typically, the pressure of the high-pressure liquid gas composition stream 107 is from 50 to 120 bar·a, preferably from 60 to 100 bar·a, more preferably from 70 to 90 bar·a.

The liquid-gas composition stream 107 produced from the liquid ejector 106 supplies a liquid-gas separator 108 which produces a liquid stream 104, typically at a pressure of from 50 to 120 bar·a, preferably from 60 to 100 bar·a, more preferably from 70 to 90 bar·a. The liquid stream 104 from the liquid-gas separator 108 may optionally be cooled before being recycled to stream 102 supplying the pump 101.

The seal gas stream 202 separated from the liquid-gas separator 108 is typically at a pressure of from 50 to 120 bar·a, preferably from 60 to 100 bar·a, more preferably from 70 to 90 bar·a. Prior to being conveyed to the seal chamber inlet, the seal gas stream 202 is typically cleaned and further dried to any necessary extent by means of one or more conditioning units (GCU) 210.

During operation of the seal on rotating equipment, such as in the case of a dry gas seal for a centrifugal compressor, significant heat can be developed in the seal gas as it flows through the inlet, through the seal chamber 203 and out through at least one outlet or vent. Depending on the seal configuration, the seal gas may be at least partially vented to the atmosphere or added to a flare stream (for instance, in the case of a tandem seal with intermediate labyrinth). Alternatively, a circular flow of seal gas may be established in which seal gas 204 leaving the seal chamber 203 through the outlet is recycled to the seal chamber 203, for instance in the case of a double seal arrangement.

FIG. 2 shows a simplified cross-sectional view of an example double seal 300 which is configured with an inlet port 301 (at 00) and an outlet port 302 (at 1800), with both inlet 301 and outlet 302 ports occupying the same axial position relative to the rotating shaft. In this arrangement, seal gas flows through the inlet port 301 and through the seal chamber and out the outlet port 302. Although a single inlet port 301 and outlet port 302 are shown in FIG. 2, alternative arrangements are possible in which multiple inlets and outlets may be provided. For example, two inlets may be provided at −/+10° and two outlets at +170/+190°. Different inlet and outlet arrangements can assist in the management of seal gas velocity through the seal chamber.

Referring again to FIG. 1, a recycle loop for seal gas typically incorporates an active cooling step using a cooling means 205 to form a cooled seal gas stream 206. The greater the pressure of the seal gas that is used in the system, the greater the temperature that may be expected to be generated in the seal gas which flows through the seal chamber 203. Use of the cooling step is preferable in most double seal arrangements.

Seal gas that has been conveyed through the seal chamber 203 and which has been committed to a cooling recycle loop may also be subjected to a gas compressor, such as a seal gas booster 207, in order to optimise the flow of the seal gas through the cooling loop. The gas stream 208 that is formed, having a pressure close to that of the seal gas stream 202 which feeds the seal chamber 203, may then be readily recycled to seal gas stream 202. However, seal gas recovery (SGR) systems may also be used to recover a seal gas stream 209, that would otherwise be leaked to the atmosphere, and recycle it to seal gas source stream 200 to form feed stream 201 for the liquid ejector 106. Integration of an SGR can be particularly beneficial in systems seeking to operate a zero emissions process.

The system and methods of the present disclosure offer the following benefits over conventional systems incorporating reciprocating compressors for providing high pressure seal gas:
Lower CAPEX;
Lower maintenance frequency—pumps are substantially more reliable than a reciprocating compressor because a pump handles liquid with minimized thermal effect in comparison to gas;
Lower Maintenance costs—pumps maintenance is significantly less expensive than that of reciprocating compressors;
Lower footprint; and
Lower personnel costs.

It should be understood that the individual steps used in the methods of the present teachings may be performed in any order and/or simultaneously, as long as the teaching remains operable. Furthermore, it should be understood that the apparatus and methods of the present teachings can include any number, or all, of the described embodiments, as long as the teaching remains operable.

Various embodiments of systems and processes have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

1. A seal system for rotating equipment operating on a process fluid, wherein the system comprises:
i) a seal configured for use with a seal gas for sealing rotating equipment;
ii) a liquid ejector subsystem comprising:
a) a liquid ejector comprising an inlet for fluidic communication with a source of liquid, an inlet for fluidic communication with a source of seal gas, and an outlet for a liquid-gas composition;
b) a liquid-gas separator, which is in fluidic communication with the outlet of the liquid ejector, for forming a separate seal gas stream and a separate liquid stream from the liquid-gas composition;
c) a pump for increasing the pressure of the liquid source for the liquid ejector; and
iii) means for conveying the seal gas stream from the liquid-gas separator of the liquid ejector subsystem to the seal;
wherein the liquid ejector subsystem is configured to increase the pressure of a supply of seal gas to the seal and arranged so that the pump is at least partly supplied by the liquid stream formed by the liquid-gas separator during operation.

2. A system according to claim 1, further comprising a seal gas recovery (SGR) subsystem for recycling seal gas otherwise lost to the atmosphere to the source of seal gas for the liquid ejector.

3. A system according to claim 1, wherein the seal system further comprises a gas conditioning unit (GCU) for filtering and/or drying the seal gas stream formed in the liquid-gas separator to remove any residual vapour and liquid particles before being conveyed to the seal.

4. A system according to claim 1, wherein the liquid ejector subsystem further comprises a cooling means for cooling the liquid stream formed by the liquid-gas separator.

5. A system according to claim 1, wherein the seal is a dry gas seal system, preferably a dry gas seal system which conforms to American Petroleum Institute (API) 692 or API 614, or wherein the seal system is a floating ring seal system.

6. A system according to claim 1, wherein the seal is a dry gas seal comprising a double seal with inboard and outboard seals in back-to-back arrangement, or wherein the dry gas seal comprises a tandem seal arrangement with an intermediate labyrinth.

7. A system according to claim 1, wherein the seal is a double seal with inboard and outboard seals in back-to-back arrangement further comprising an outlet between the inboard and outboard seals of the double seal to allow outward flow of seal gas from the seal chamber, wherein the system comprises a cooling means for cooling seal gas exiting the double seal via the outlet, and further comprising means for recycling the cooled seal gas back to a seal gas inlet stream for the seal.

8. A system according to claim 7, wherein the system further comprises a gas compressor configured to increase the pressure of the cooled seal gas prior to recycle to the seal gas inlet stream for the seal.

9. A system according to claim 1, wherein the pump is a centrifugal, reciprocating, or rotary pump.

10. A system according to claim 1, wherein the liquid ejector subsystem is configured to provide seal gas streams for a plurality of seals.

11. A process for providing a seal gas for a seal configured for use with a seal gas for sealing rotating equipment operating on a process fluid; said process comprising the following steps:
i) providing a liquid ejector comprising an inlet for fluidic communication with a source of liquid, an inlet for fluidic communication with a source of seal gas, and an outlet for a liquid-gas composition;
ii) providing a source of liquid and a source of seal gas to the liquid ejector, wherein the pressure of the source of liquid is higher than that of the source of seal gas, and forming a liquid-gas composition;
iii) separating a seal gas stream and a liquid stream from the liquid-gas composition, said seal gas stream having a higher pressure than the source of seal gas provided to the liquid ejector; and
iv) conveying the seal gas stream obtained from the liquid-gas separator to the seal.

12. A process according to claim 11, wherein the process further comprises pumping a liquid source with a pump to provide a pressurised source of liquid for the liquid ejector, preferably wherein the pump is a centrifugal, reciprocating, or rotary pump.

13. A process according to claim 12, wherein the source of liquid which is provided to the pump is at least partly supplied by a liquid recycle stream separated from the liquid-gas composition formed by the liquid ejector.

14. A process according to claim 13, wherein the process further comprises cooling the liquid recycle stream separated from the liquid-gas composition using a cooling means before the stream is recycled to the pump.

15. A process according to claim 11, wherein the source of liquid for the liquid ejector has a pressure of from 200 to 500 bar·a, preferably from 250 to 450 bar·a, or more preferably 275 to 325 bar·a.

16. A process according to claim 11, wherein the process further comprises filtering and/or drying the seal gas stream separated from the liquid-gas composition to remove any residual vapour and liquid particles before being conveyed to the seal.

17. A process according to claim 11, wherein the source of seal gas provided to the liquid ejector is at a pressure of less than 10 bar·a, preferably from 1 to 6 bar·a, more preferably from 1 to 4 bar·a.

18. A process according to claim 11, wherein the seal gas is selected from nitrogen, carbon dioxide, air, and combinations thereof.

19. A process according to claim 11, wherein the seal gas stream separated from the liquid-gas composition formed by the liquid ejector has a pressure of from 50 to 120 bar·a, preferably from from 60 to 100 bar·a, more preferably from 70 to 90 bar·a.

20. A process according to claim 11, wherein the seal gas stream provided to the seal is at least 5 bar, preferably at least 10 bar higher in pressure than the process fluid on which the rotating equipment operates.
